(19) United States
(12) Patent Application Publication
(10) Pub. No.: US 2010/0306231 A1
(43) Pub. Date: Dec. 2, 2010

(54) COLLABORATIVE SEARCH TOOLS

(75) Inventors: Danyel Fisher, Seattle, WA (US); Kori Marie Quinn, Redmond, WA (US); Meredith Morris, Bellevue, WA (US); Petra Isenberg, Groningen (NL)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/472,384

(22) Filed: May 27, 2009

(51) Int. Cl. G06F 17/30; G06F 3/048

(52) U.S. Cl. 707/769; 715/764; 345/173; 707/708

(57) ABSTRACT

Described herein are technologies pertaining to search in general, and collaborative searching in particular. Graphical items are generated that are representative of searches. The graphical items include graphical indicia that indicate which search results were included in other, related searches.

### BACKGROUND

Advances in computing technologies have allowed individuals and companies to collect, store and maintain incredibly large amounts of information in the form of electronic documents, images, etc. Typically this information is organized through use of file folders, wherein a name and location of a file folder may correspond to a particular schema for organizing documents. To locate a certain document, a user can traverse through one or more file folders until a folder that includes the desired information is located.

Search tools can also be utilized in connection with locating certain information. For example, the user can enter a search query into a query field and cause a search algorithm to execute over contents in a selected drive/folder, etc. The user may then be provided with documents that have been located through utilization of the search algorithm.

Search engines have also been designed in an effort to aid in locating information available by way of the Internet. Again, a user can enter a search query into a search engine and the search engine can provide the user with a ranked list of results, wherein a most relevant result (as determined by the search engine) is displayed most prominently to the user while other less relevant results are displayed less prominently to the user. The user can then review the search results and select a search result that the user believes to be pertinent to informational needs of the user. Additionally or alternatively, the user may provide the search engine with a new search query.

Due to the ever increasing amount of information that can be stored (e.g., locally on a personal computer, for example, or on servers accessible by way of the Internet), locating information that meets informational needs of a user is often a difficult task. Meeting information needs of users becomes more complex when two or more users are attempting to work collaboratively to complete a common task. For example, a first user will typically not have knowledge of searches performed by a second user. Therefore, a significant amount of redundancy can exist in collaborative projects that include tasks pertaining to searching for information.

### SUMMARY

The following is a brief summary of subject matter that is described in greater detail herein. This summary is not intended to be limiting as to the scope of the claims.

Described herein are various technologies pertaining to informational searches in general and collaborative searches in particular. While examples provided herein pertain to two individuals performing a collaborative search, it is to be understood that aspects described herein can pertain to more than two individuals collaboratively searching. Furthermore, some aspects described herein may pertain to a single searcher.

In an example, two individuals may wish to work collaboratively to complete a common task and/or to obtain information pertaining to a task. The two individuals may work together on a single computing device such as a touch sensitive table top surface computing device. In another example, the two users may be in two separate locations using two different computing devices that are in communication with one another by way of a network. The two users may wish to perform searches over a data repository, wherein the data repository can be located on a single computing device or distributed across several computing devices (e.g., the data repository may include servers that host information accessible by way of the Internet).

A first of the two users may provide a search tool (such as a search engine) with a first search query. A search can be executed based at least in part upon the first search query and a first set of search results can be located upon executing the search. A graphical item may be generated and displayed to the first user and/or the second user, wherein the graphical item is representative of the search performed based upon the first received search query. Furthermore, the graphical item may be provided with a color or shape that indicates that the first the first search query was issued by the first user. The graphical item may be expandable and representations of search results located based upon the first search query can be presented to the first and/or second user upon the graphical item being expanded.

In addition, the second user may be attempting to locate related information and may generate a second search query that is provided to the search tool. The search tool can output a plurality of search results based at least in part upon the search query received from the second user. Similarly to what has been described above, a graphical item that is representative of the search performed by the second user can be generated and displayed to the first and/or second user, wherein the graphical item can be of a particular color or shape to indicate that the search was initiated by the second user. The second graphical icon can be expandable, wherein expansion provides a user with a plurality of graphical icons that are representative of search results returned by the search algorithm responsive to receipt of the query issued by the second user.

The representations of the search results in the first graphical item and/or the second graphical item can have data corresponding thereto that can indicate to the first user and/or the second user that there is commonality between the search results pertaining to the first query issued by the first user and the second query issued by the second user. Thus, the first user can quickly ascertain that a search result located by the first user (and found by the search tool through execution of the query issued by the first user) was also located by the second user that has a similar or related informational goal. Therefore, the first user and/or the second user can infer that such search result may be especially relevant to the task being performed collaboratively by the first user and the second user.

Other aspects will be appreciated upon reading and understanding the attached figures and description.

### BRIEF DESCRIPTION OF THE DRAWINGS

FIG. 1 is a functional block diagram of an example system that facilitates generating graphical items that are representative of searches.

FIG. 2 illustrates a plurality of example graphical items.

FIG. 3 illustrates a graphical item that is expanded to illustrate graphical representations of search results.

FIG. 4 illustrates an example graphical item representative of a search, wherein a pointing mechanism is hovered over a representation of a search result.

FIG. 5 illustrates an example graphical item that depicts that a particular search result has been read.

FIG. 6 illustrates an example document that comprises a glyph to indicate which searcher has read the document.

FIG. 7 illustrates two users collaborating on a touch sensitive table top surface computing device.

FIG. 8 illustrates two users collaborating on separate computing devices over a network.

FIG. 9 is a flow diagram that illustrates an example methodology for displaying a graphical item that is representative of a search.

FIG. 10 is a flow diagram that illustrates an example methodology for displaying a graphical item that is representative of a search.

FIG. 11 is an example computing system.

### DETAILED DESCRIPTION

Various technologies pertaining to search in general and collaborative searching in particular will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

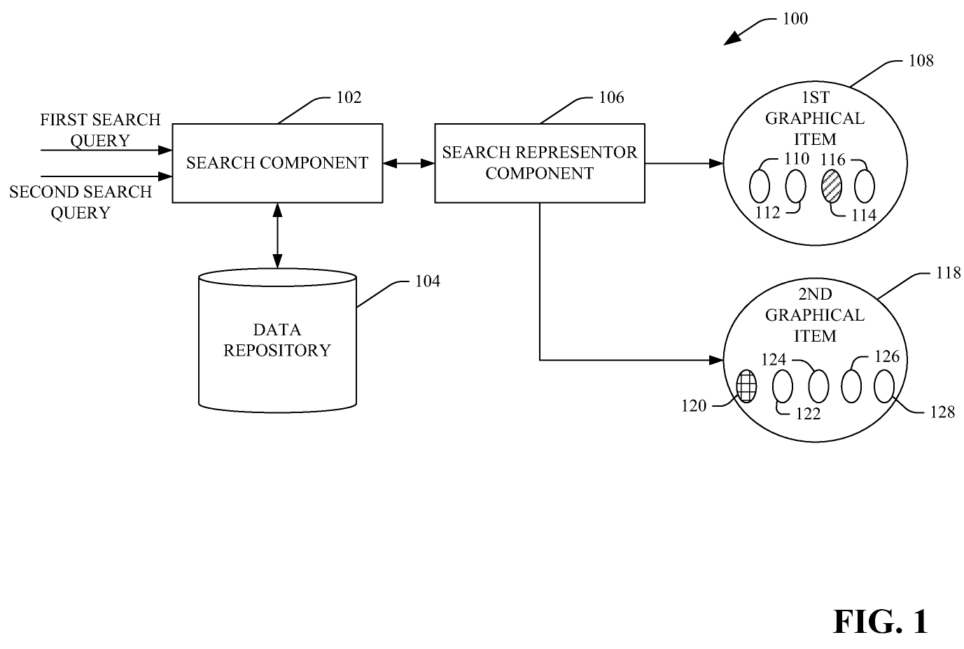

With reference to FIG. 1, an example system 100 that facilitates generating graphical representations of searches is illustrated. The system 100 includes a search component 102 that receives a first search query and also receives a second search query. In an example, the system 100 may be used in a collaborative setting where two users are performing searches to obtain information pertaining to a common or related informational goal or task. Furthermore, as will be described herein, the first user and the second user may be utilizing a common computing device such as a touch sensitive tabletop surface computing device. In another example, the first user and the second user may be located at different geographic locations and may be using two separate computing devices that are in communication with one another by way of a network connection. While some examples provided herein describe a collaborative search setting, it is to be understood that systems, methods, graphical user interfaces, etc. that are described herein may also apply to a single user search setting.

The system 100 further includes a data repository 104 that can retain data that can be searched over by the search component 102. Data in the data repository 104 may include, for example documents, images, hyperlinks, videos or other suitable types of data. Furthermore, the data repository 104 may reside on a single computing device. For instance, continuing with an example provided above, the data repository 104 may reside on a touch sensitive tabletop surface computing device. In another example, the data repository 104 may be distributed across several computing devices. For instance, the data repository 104 can represent a plurality of data repositories used to store data that is accessible by a web-based search engine.

The search component 102 can execute a first search over contents of the data repository 104 based at least in part upon the first search query received by such search component 102. As can be understood, the first search query and the second search query can be text-based queries that are in the form of a word, a phrase, an acronym or other suitable letters and/or numbers. The search component 102 can output a first set of search results that are based at least in part upon the first search query. Additionally, the search component 102 can execute a search over contents of the data repository 104 based at least in part upon the second search query received by the search component 102. The search component 102 may output a second set of search results that are located through use of the second search query. The search component 102, in an example, may be configured to execute a search over contents of the Internet (e.g., execute a web-based search). Thus, the search component 102 may be or may be included in a web-based search engine. In another example, the search component 102 may be a computer desktop search application or be included in such application and thus may be configured to search over contents in a selected drive on a computer device in a particular folder or set of folders on a computer device, etc.

The system 100 further includes a search representor component 106 that is in communication with the search component 102. The search representor component 106 can receive various information pertaining to searches executed by the search component 102. For instance, the search representor component 106 can receive the first query and the second query, search results located through use of the first search query and the second search query (e.g., the first set of search results and the second set of search results), identities of issuers of the first search query and the second search query, times that the first search query and the second search query were issued, amongst other data.

Based at least in part upon information received from the search component 102, the search representor component 106 can generate a first graphical item 108 that is representative of the first search performed by the search component 102. The search representor component 106 can cause the first graphical item 108 to be displayed on a display screen of a computing device. For instance, and as will be described in greater detail below, the first graphical item 108 can be assigned a particular color that uniquely identifies the search and/or an issuer of the first query that the search is based upon. In a specific example, all searches initiated by a first user can be assigned a particular shade of a color, wherein different shades of such color indicate different searches performed by the first user. Furthermore, the search representor component 106 can cause the first graphical item 108 to include a title that identifies the search represented by the first graphical item 108. For instance, such title may be all or part of the first search query.

Additionally, the search representor component 106 can cause the first graphical item 108 to be expandable such that upon receipt of a user command the first graphical item 108 is expanded to provide the user with additional detail pertaining to the first search represented by the first graphical item 108. For instance, the graphical item 108 when expanded can include a plurality of graphical items 110, 112, 114 and 116 that are representative of search results in the first set of search results that were output by the search component 102 based at least in part upon the first search query. This plurality of graphical items 110-116 may be arranged in the first graphical item 108 based upon any suitable criteria. For instance, the plurality of items 110-116 may be arranged based upon computed relevance of the search results to the first search query, such that the graphical item 110 is found to be the most relevant search result which the graphical item 116 is found to be the least relevant search result. In another example, the graphical items 110-116 may be arranged based at least in part upon time of creation of each of the search results 110-116. Thus, for instance, the graphical item 110 can represent a search result created earlier in time than a search result represented by the graphical item 116. In still yet another example, the graphical items 110-116 can be arranged based upon alphabetical order, numerical order, or any other suitable criteria.

The search representor component 106 can also create a second graphical item 118 that is representative of the second search performed by the search component 102 that is based upon the second search query. Similar to what has been described above, the second graphical item 118 can be displayed on a display screen of a computing device in such a way as to identify the second search and/or the issuer of the second search query. Further, the second graphical item 118 may be expandable and upon receipt of a command to expand such graphical item 118, a plurality of graphical items 120-128 can be depicted, where the graphical items 120-128 represent search results that are output based upon the second search query (e.g., the second set of search results). Again, the graphical items 120-128 may be arranged in any suitable manner. For instance, arrangement of the graphical items 120-128 may be customized by a user.

Pursuant to an example, in a collaborative search setting, the search representor component 106 can cause the first graphical item 108 and the second graphical item 118 to be displayed to both the first user and the second user (or any other users participating in a collaborative search). For instance, if the collaborative search is being performed on a touch sensitive tabletop surface computing device, the first graphical item 108 and the second graphical item 118 can be displayed and accessible to both the first user and the second user on the touch sensitive tabletop surface computing device. When collaborative searchers are using different computing devices, graphical items representative of searches performed by other collaborative searchers can be displayed on computing devices of users that did not initiate the search.

The search representor component 106 may further ascertain that at least some overlap in search results exists between the search represented by the first graphical item 108 and the search represented by the second graphical item 118. For instance, the search representor component 106 can cause at least one of the graphical items 110-116 in the first graphical item 108 to have a graphical indicia corresponding thereto that indicates that a search result corresponding to the first graphical item 108 is also included in search results corresponding to the second graphical item 118 (search results corresponding to the search performed by the search component 102 based upon the second search query). For instance, and as will be described in greater detail herein, the search representor component 106 can determine that a search result corresponding to the graphical item 114 was also included in the search results based upon the second search query. Accordingly, the search representor component 106 can assign graphical indicia to the graphical item 114 to notify a reviewer of the first graphical item 108 that a search result corresponding to the graphical item 114 was also included in other search results of another search (e.g., a search performed by a different user). This overlap in search results may indicate to a searcher that the search result corresponding to the graphical item 114 is particularly relevant to be collaborative information goal or task.

In addition, the search representor component 106 can assign the graphical indicia to the graphical item 114 to identify the other search used to locate a search result represented by the graphical item 114 and/or an identity of the searcher that caused the other search to be performed. As noted above, the first graphical item 108 and the second graphical item 118 can be assigned a color or shade of color to indentify an issuer of the search represented by the graphical items 108 and 118 and/or the search itself. Thus, for instance, the second graphical item 118 can be assigned a particular shade of blue while the first graphical item 108 can be assigned a particular shade of orange to identify a searcher and identify the search. Thus, if a search result represented by the graphical item 114 was also located in the search represented by the second graphical item 118, the graphical item 114 can be assigned a color corresponding to the second graphical item 118. Assignment of such a particular shade of a certain color can quickly indicate to a reviewer of the first graphical item 108 that a search represented by the second graphical item 118 also includes the search represented by the graphical item 114.

The search representor component 106 can also cause graphical indicia to be assigned to the graphical item 120 to indicate that the search result represented by the graphical item 120 was also located in the search represented by the first graphical item 108. Thus, a single searcher using the system 100 can quickly and easily determine which search results were located using different searches in a related informational goal. Similarly, collaborative searchers can quickly ascertain which searches performed by different searchers were used to locate common search results.

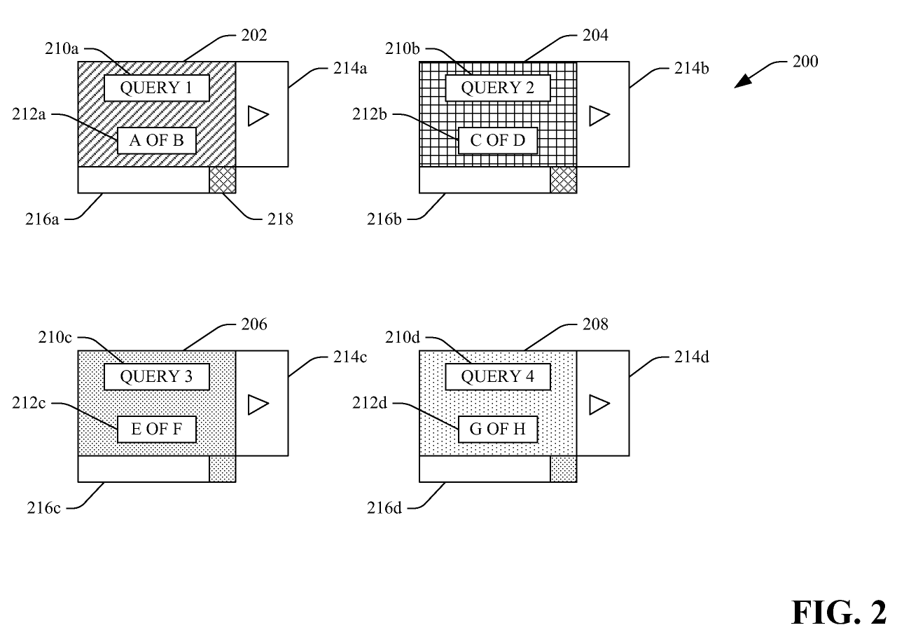

Turning now to FIG. 2, an example depiction 200 of a plurality of graphical items that represent a corresponding plurality of searches is illustrated. Specifically, the depiction 200 includes a first graphical item 202 that represents a first search, a second graphical item 204 that represents a second search, a third graphical item 206 that represents and third search, and a fourth graphical item 208 that represents a fourth search. In an example, the first graphical item 202 and the second graphical item 204 can represent searches initiated by a particular user. Accordingly, the graphical item 202 and the graphical item 204 can be assigned shades of a particular color, wherein the particular color can identify the user that initiated the searches represented by the first graphical item 202 and the second graphical item 204. For instance, the first user may be assigned the color blue and therefore the first graphical item 202 can be rendered in a first shade of blue and the second graphical item 204 can be rendered in a second shade of blue. Similarly, the third graphical item 206 and the fourth graphical item 208 can represent searches that are initiated by a second user and thus may be assigned shades of a color that identifies the second user. Pursuant to an example, the second user can be assigned the color orange and thus the third graphical item 206 can be rendered in a first shade of orange and the fourth graphical item 208 can be rendered in a second shade of orange. Therefore, a reviewer of the graphical items 202-208 can quickly ascertain which user initiated which search as represented by the graphical items 202-208.

Additionally each of the graphical items 202 through 208 can include a field 210a, 210b, 210c, and 210d, wherein contents of such field may be names of the corresponding graphical items 202-208. In an example, names assigned to the graphical items 202-208 can be search queries or portions thereof used to initiate the search represented by such graphical items 202-208.

Further, each of the graphical items 202-208 may include fields 212a, 212b, 212c, and 212d that indicate a number of search results that correspond to the search. The fields 212a-212d may also indicate a number of search results that have been read by one or more users. Thus, for instance the field 212a of the first graphical item 202 may indicate that the search represented by the graphical item 202 has thirty search results corresponding thereto, and that five of such search results have been read/reviewed by one or more users.

As noted above, the graphical items 202-208 can be expandable such that the graphical items 202 through 208 provide additional information to users when expanded. Thus, each of the graphical items 202-208 can include expansion tabs 214a, 214b, 214c, and 214D. The user may expand one of the graphical items 202-208 by selecting one of the corresponding tabs 214a-214d, for instance, with a pointing and clicking mechanism, with a finger on a touch sensitive tabletop surface computing device, etc.

Furthermore, the graphical items 202-208 may include tabs 216a-216d that can indicate to reviewers thereof identities of user that are actively reviewing a search corresponding to one of the graphical items 202. For example, the tab 216a may include a portion 218 that is assigned a particular color corresponding to a certain user. Thus, a reviewer of the graphical item 202 can quickly ascertain that a user corresponding to the color in the portion 218 of the tab 216a is currently reviewing search results corresponding to the search represented by the graphical item 202. If multiple users are reviewing search results corresponding to the graphical item 202, the tab 216a can include multiple portions that are assigned colors corresponding to the users that are reviewing the graphical item 202.

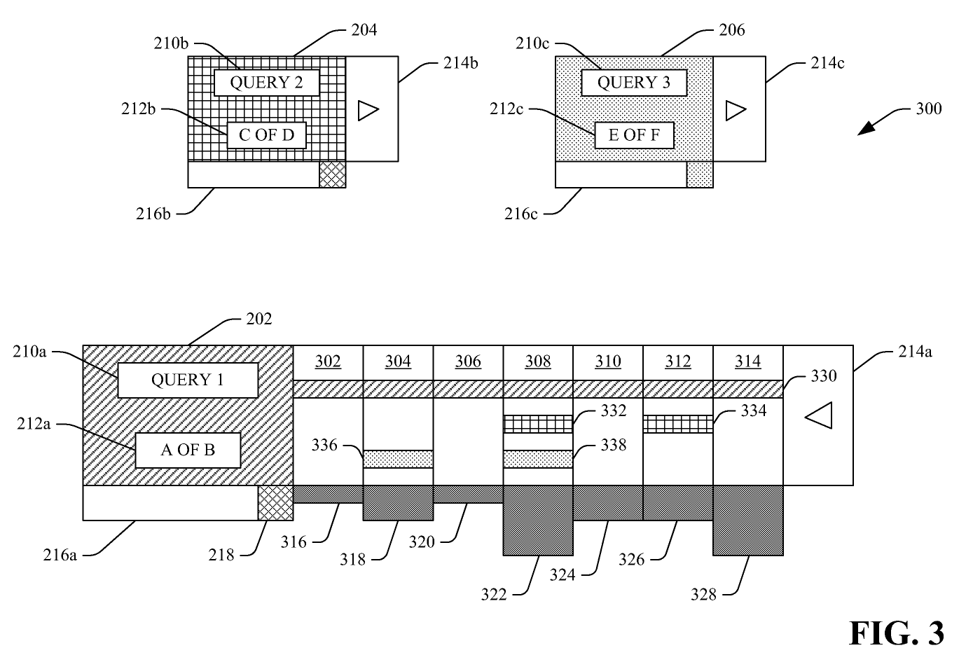

Referring now to FIG. 3, an example depiction of graphical items that represent searches is illustrated. The depiction 300 includes the graphical items 202, 204 and 206. As shown, the graphical item 202 has been expanded. Expansion of the graphical item 202 can cause additional information pertaining to the search represented by the graphical item 202 to be displayed on the computer display screen.

When the graphical item 202 is expanded, a plurality of graphical items 302-314 can be displayed on the computer display screen to a user. These graphical items 302-314 each represent a search result in the search results returned upon the search represented by the graphical item 202 being executed. In this example, the graphical item 202 represents a search, wherein seven search results are returned upon executing such search. A first search result is represented by the graphical item 302, a second search result is represented by the graphical item 304, and so on. As can be discerned, each of the graphical items 302-314 are depicted as rectangles. It is to be understood, however, that the graphical items 302-314 may be of any suitable shape.

One or more of the graphical items 302-314 may have graphical indicia associated therewith that provides additional information pertaining to search results represented by such graphical items 302-314. For instance, such indicia may be extensions 316-328 of varying lengths from the graphical items 302-314, wherein the extensions 316-328 can be indicative of, for instance, relevance of search results pertaining to the graphical items 302-314, a number of occurrences of query terms in the search results represented by the graphical items 302-314, etc. In an example, the graphical items 302-314 may be arranged in accordance with time of creation of search results represented thereby. The graphical indicia (extensions) 316-328 can represent a number of occurrences of query terms in such search results. Thus, for example, a search result pertaining to the graphical item 314 may have more occurrences of query terms used for the search than the search result pertaining to the graphical item 302.

Furthermore, one or more of the graphical items 302-314 may include graphical indicia that indicates which searches correspond with the search results represented by the graphical items 302-314. For example, each of the graphical items 302-314 may include a line 330 that indicates that each of the graphical items 302-314 represents a search result obtained through use of the search represented by the graphical item 202. For instance, the line 330 may be of a color or shade of color that is assigned to the graphical item 202 that represents the search.

Additionally, the graphical items 308 and 314 may include lines 332 and 334, respectively, that indicate that search results represented by the graphical items 308 and 312 were also located through the search represented by the graphical item 204. Furthermore, the graphical items 304 and 308 of the graphical item 202 may include graphical indicia (lines) 336 and 338, respectively, that indicate that the search results represented by graphical items 304 and 308 were also found through use of the search represented by the graphical item 206. The lines 336 and 338 may be assigned a color or shade of color that is substantially similar to the color or shade of color of the graphical item 206. Thus, in this example, a user can infer that the search result corresponding to the graphical item 308 may be particularly relevant to an informational goal in a collaborative search, as such result was returned through utilization of three different queries that were crafted for obtaining information for a common or related informational goal. While the example depicted in FIG. 3 shows one possible implementation of a graphical item that represents a search, it is to be understood that other implementations are also contemplated and intended to fall under the scope of the hereto appended claims. For example, rather than using lines to indicate which searches return particular search results, text or other shapes can be used to convey other such information to a user.

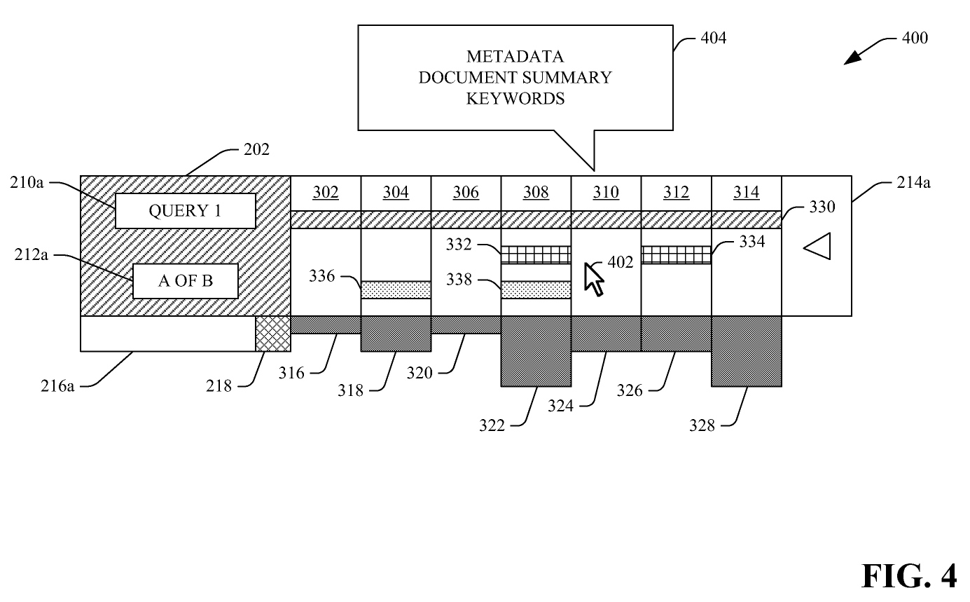

Referring now to FIG. 4, an example graphical item 400 that represents a search is illustrated. In this example, a graphical pointer 402 is positioned over the graphical item 310 that represents one of the search results returned in a search represented by the graphical item 202. Upon hovering over the graphical item 310, a display window 404 can be presented on a display screen of a computer device. The display window 404 can present information pertaining to the search result represented by the graphical item 310 to the user. Such information may include metadata such as when the search result was created, an identity of the individual that created the search result, when the search result was edited, an identity of one or more editors of the search result, etc. Furthermore, the information window 404 may include a document summary. For example, the summary may include sentences that comprise certain keywords used in the query to perform the search. The information window 404 may also display certain keywords that describe text or images in the search result represented by the graphical item 310.

While FIG. 4 illustrates the graphical pointer 402 as hovering over the graphical item 310, it is to be understood that on a touch sensitive screen a finger may be used to select the graphical item 310 and cause the information window 404 to appear. Furthermore, upon hovering over the graphical item 310, shape of the graphical item 310 may change to display information therein pertaining to the search result represented by the graphical item 310. Furthermore, the information window 404 may provide information pertaining to which searchers have read the search result represented by the graphical item 310. This information may be in the form of text, a graphical indicia, etc.

Upon selecting the graphical item 310, a full size version or an expanded version of a search result represented by the graphical item 310 can be displayed. For instance, selecting the graphical item 310 may cause an application to be initiated, wherein the application can be used in connection with viewing/editing the search result represented by the graphical item 310. Once the search result has been opened, the user may view, edit, minimize the search result back into the graphical item 310, share the search result with another searcher, etc.

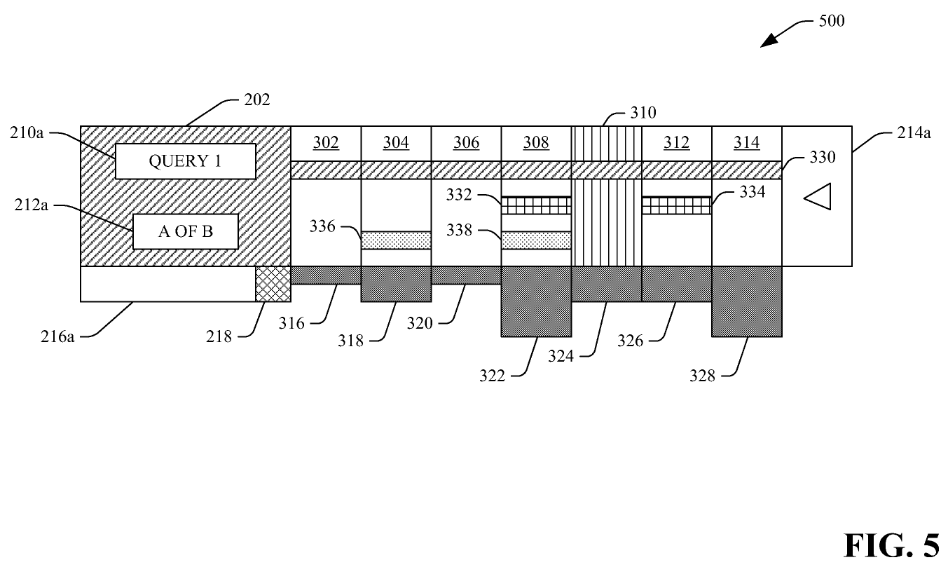

With reference now to FIG. 5, an example depiction of the graphical item 202 that represents a particular search is illustrated. The search representor component 106 (FIG. 1) can cause appearance of one or more of the graphical items 302-314 to alter as documents represented by such items 302-314 are read by a searcher or searchers. In this example, the graphical item 310 may be shaded a particular color, such as grey, to indicate that the search result represented by the graphical item 310 has been opened and read by at least one searcher. As the search result represented by the graphical item 310 is opened and read additional times, the color or shade of color assigned to the graphical item 310 can alter. For instance, if the search result represented by the graphical item 310 is opened and read a single time, the graphical item 310 can be assigned a light grey color. If the search result corresponding to the graphical item 310 is opened and read by another searcher, the graphical item 310 can be assigned a darker shade of grey.

Furthermore, the graphical item 310 may be assigned another graphical indicia to indicate to a reviewer of the graphical item 202 that another searcher is currently viewing the search result represented by the graphical item 310. For instance, a border of a certain color may be assigned to the graphical item 310 to indicate that a search result corresponding to the graphical item 310 is currently being viewed by another searcher. Again, other graphical indicia are also contemplated to inform a reviewer of the graphical item 202 that a certain search result is being viewed. For instance, a blinking graphical icon may be assigned to the graphical item 310 to indicate to a reviewer of the graphical item 202 that another searcher is currently viewing the search result represented by the graphical item 310.

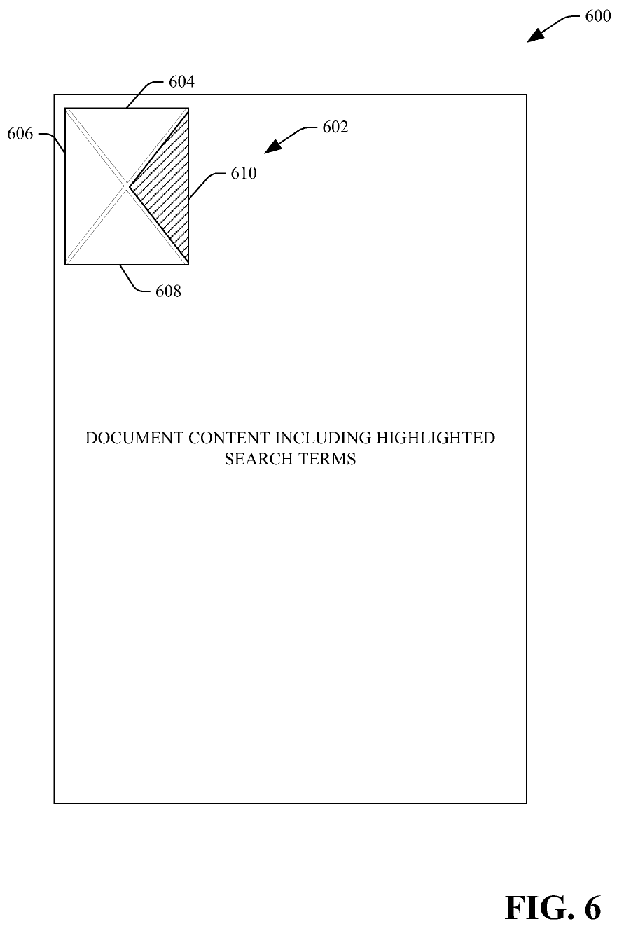

Referring now to FIG. 6, an example depiction of a document 600 opened from a graphical item that represents a search (such as a graphical item 202) is illustrated. The search result/document 600 includes content such as text, images, hyperlinks, video data, etc. Document text that corresponds to search terms used in the search query to initiate the search employed to locate such document 600 can be highlighted. Furthermore, a searcher can initiate a new search by highlighting text in the document 600 and initiating a command to undertake a new search using such text as a search query. Initiating such a command can cause a search to be performed and a new graphical item to be generated and displayed on a computer display device. As described above, the graphical item may be rendered in a particular color to identify the search and/or the searcher who initiated such search.

The document 600 may further include a glyph 602, wherein different portions of the glyph 602 may pertain to different searchers undertaking a collaborative search. In the example document 600, the glyph 602 is shown to include four separate portions 604, 606, 608 and 610 that correspond to four different searchers that are collaboratively searching. Contents of the portions of the glyph can indicate whether or not a searcher corresponding to such portions has read the document 600. In the example shown in FIG. 6, the portion 610 of the glyph 602 is rendered in a color that corresponds to a particular searcher. Thus, it can be ascertained from reviewing the glyph 602 that the searcher corresponding to the color depicted in the portion 610 has opened and reviewed the document 600. While the glyph 602 is shown to be of a particular shape with a certain number of portions, it is to be understood that any suitable manner of indicating to a reviewer who has reviewed the document in a collaborative search setting is contemplated by the inventors and is intended to fall under the scope of the hereto appended claims. For example rather than using a graphical glyph, text may be used to indicate which searcher has reviewed the document 600.

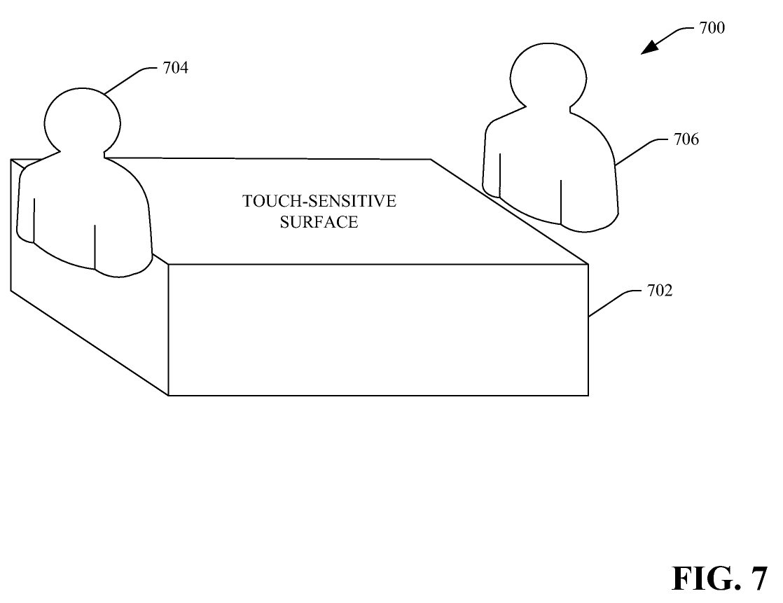

Turning now to FIG. 7, an example collaborative search environment 700 is illustrated. For instance the collaborative search environment 700 may refer to two or more users interacting on a touch sensitive tabletop surface computing device. Specifically, the collaborative search environment 700 includes a touch sensitive tabletop surface computing device 702. A first user 704 and a second user 706 may be assigned to collaborate on a certain project, wherein such collaboration may include searching for certain information. Thus, the first user 704 and the second user 706 may utilize the touch sensitive tabletop surface computing device 702 to collaborate when performing a search. For example, the first user 704 and the second user 706 may perform searches during a search session when both the first user 704 and second user 706 are simultaneously using the touch sensitive tabletop surface computing device 702. The first user 704 and the second user 706 can generate search queries that are executed by a search component (e.g., search engine) and can cause graphical items described herein that represent searches to be displayed. Once the graphical items are created and displayed, the first user 704 and/or the second user 706 can pass graphical items therebetween, can utilize such graphical items as described above, etc. Furthermore, when a document is opened using a graphical item described herein, the users can pass such documents therebetween using the touch sensitive table top surface computing device 702.

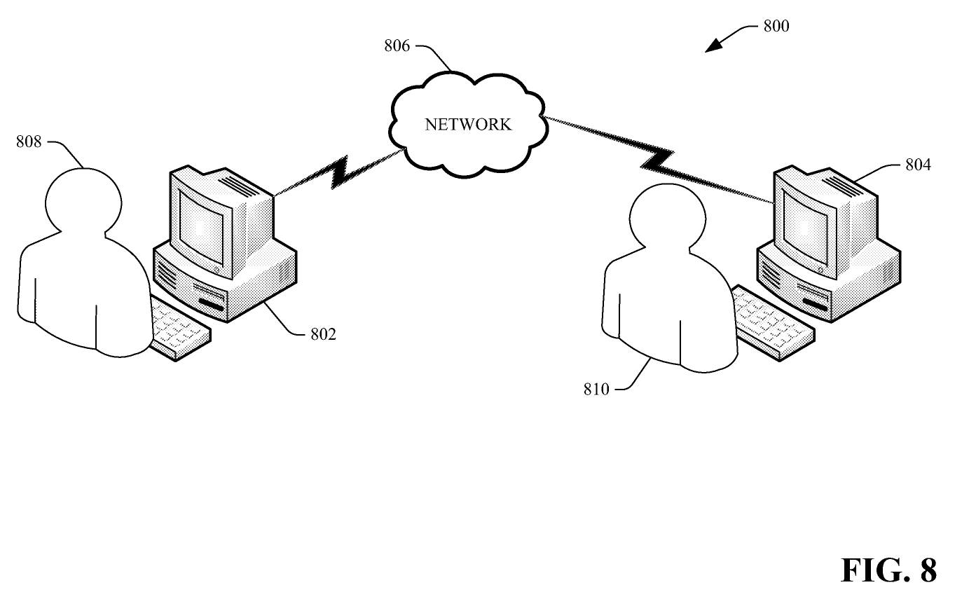

Now referring to FIG. 8, an example collaborative search environment 800 is illustrated. In this example a first computer 802 and a second computer 804 are in communication with one another by way of a network 806. The first computer 802 is utilized by a first user 808 while the second computer 804 is utilized by a second user 810. The first user 808 and the second user 810 may be performing a collaborative process that involves searching for related information. The first user 808 and the second user 810 may initiate execution of an application on the respective computers 802 or 804 to initiate a collaborative search session. For example, initialization of the collaborative search session may allow the first user 808 and the second user 810 to view a common graphical interface on the first computer 802 and the second computer 804.

As described above, the first user 808 and the second user 810 may proffer queries to a search component which can execute a search based upon received queries, locate search results, and can cause graphical items representing the searches to be generated. Graphical items generated at the first computer 802 may be displayed on the second computer 804 operated by the second user 810. Thus, the second user 810 can review searches performed by the first user 808. Similarly, the first user 808 can review searches initiated by the second user 810 on the display screen of the first computer 802.

It is to be understood that the first user 808 and the second user 810 do not need to be performing searches at substantially similar times. That is, the first user 808 may perform a first plurality of searches in the morning on the first computer 802 and the second user 810 can perform a plurality of searches in the evening on the second computer 804 and may review the searches performed by the first user 808 on the second computer 802. When the first user 808 logs back into the collaborative environment, the first user 808 can review searches performed by the second user (e.g., may review graphical items that represent searches performed by the second user 810).

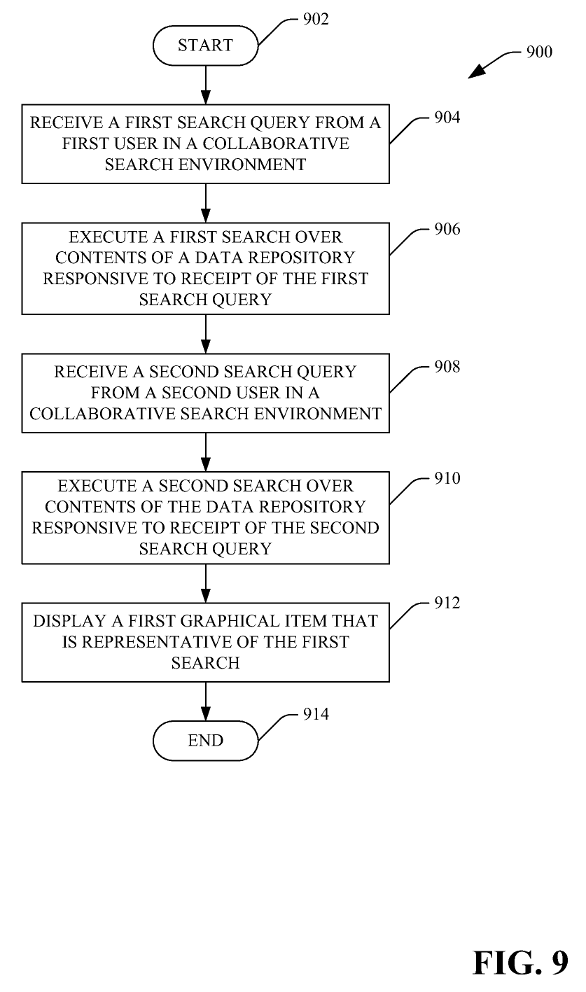

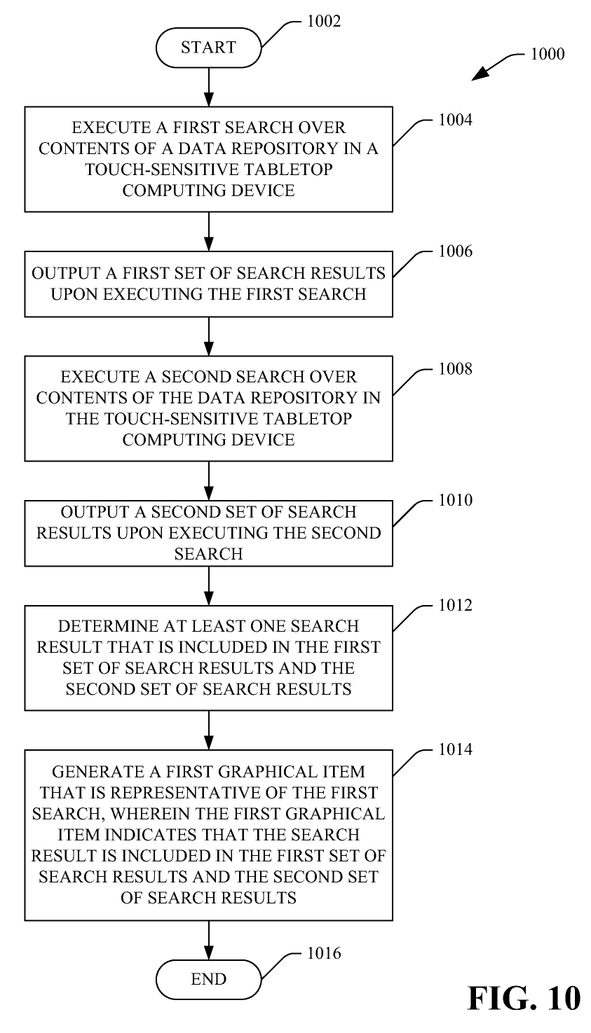

With reference now to FIGS. 9 and 10, various example methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like.

Referring now to FIG. 9, a methodology 900 that facilitates display of a graphical item that represents a search is illustrated. The methodology 900 begins at 902, and at 904 a first search query issued by a first user in a collaborative search environment is received. As noted above, the collaborative search environment may include a computer device that is simultaneously being utilized by the first user and the second user such as a touch sensitive tabletop surface computing device. In another example, the collaborative search environment may include a networked environment, wherein the first user is utilizing a first computing device that is in communication with a second computing device utilized by a second user.

At 906, a first search is executed over contents of a data repository responsive to receipt of the first query received at 904. At 908, a second search query issued by a second user in the collaborative search environment is received, and at 910 a second search over contents of the data repository is executed responsive to receipt of the second search query received at 908. In an example, the first executed search and the second executed search may be web-based searches conducted through use of a web browser and a web-based search engine. In another example, the first search and the second search may be over contents of a common data repository (such as a desktop search).

At 912, a first graphical item is displayed on a display screen of a computing device, wherein the first graphical item includes first indicia that represents a first set of items retrieved during execution of the first search. The first graphical item can include second indicia that identifies a subset of items in the first set of items retrieved during execution of the first search that were also retrieved during execution of the second search. Furthermore, a second graphical item can be displayed that is representative of the second search. Similar to the first graphical item, the second graphical item can include third indicia that represents a second set of items retrieved during execution of the second search. The second graphical item may comprise fourth indicia that identifies a subset of items in the second set of items retrieved during execution of the second search that were also retrieved during execution of the first search. As described above, colors corresponding to particular searchers may be included in the graphical items to indicate which search results were reviewed by which searchers.

Now referring to FIG. 10, a methodology 1000 pertaining to generating a graphical item that is representative of a search is illustrated. For example, the methodology 1000 can be configured to execute in a touch sensitive table top surface computing device, wherein such touch sensitive table top surface computing device comprises a processor and a computer readable medium.

The methodology starts at 1002, and at 1004 a first search is executed over contents of a data repository in the touch sensitive table top surface computing device, wherein the first search is executed responsive to receipt of a search query issued by a first user of the touch sensitive tabletop surface computing device.

At 1006, a first set of search results are output upon executing the first search. The first set of search results may include documents, spreadsheets, images, etc.

At 1006, a second search is executed over contents of the data repository in the touch sensitive tabletop surface computing device, wherein the second search is executed responsive to receipt of a search query issued by a second user of the touch sensitive tabletop surface computing device.

At 1010, a second set of search results is output upon executing the second search. Similar to what has been described above, the second set of search results may include documents, images, videos, etc.

At 1012, a determination is made that at least one search result is located in both the first set of search results and the second set of search results.

At 1014, a first graphical item is generated that is representative of the first search. The first graphical item comprises a plurality of graphical items that are representative of search results in the first set of search results. Further, at least one graphical item comprises a first graphical indicia that indicates that a search result corresponding to the at least one graphical item is included in both the first set of search results and the second set of search results. The methodology 1000 completes at 1016.

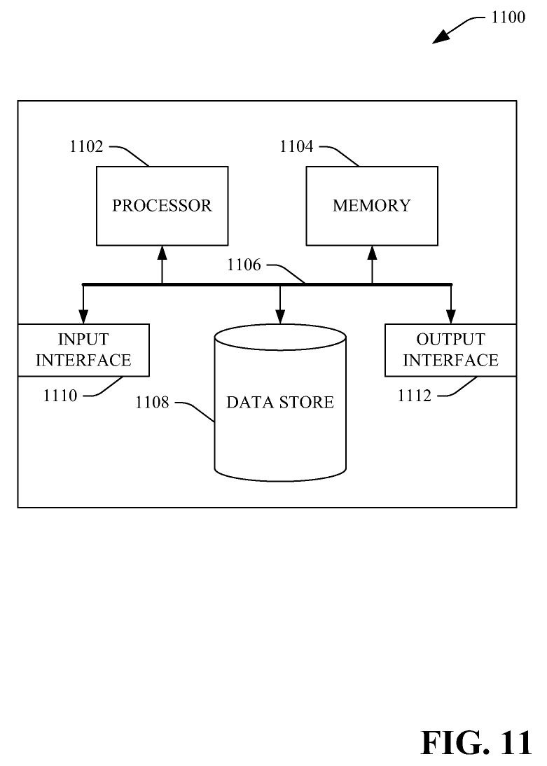

Now referring to FIG. 11, a high level illustration of an example computing device 1100 that can be used in accordance with the systems and methodologies described herein is illustrated. For instance, the computing device 1100 may be used in a system that supports collaborative search. In another example at least a portion of the computing device 1100 may be used in a system that supports generation of graphical items that are representative of searches. The computing device 1100 includes at least one processor 1102 that executes instructions that are stored in a memory 1104. The instructions may be, for instance, instructions for implementing functionality described as being carried out by one or more components discussed above or instructions for implementing one or more of the methods described above. The processor 1102 may access the memory 1104 by way of a system bus 1106. In addition to storing executable instructions, the memory 1104 may also store search results, applications utilizing connection with collaborative searching, etc.

The computing device 1100 additionally includes a data store 1108 that is accessible by the processor 1102 by way of the system bus 1106. The data store 1108 may include executable instructions, search results, graphical items representative of searches, etc. The computing device 1100 also includes an input interface 1110 that allows external devices to communicate with the computing device 1100. For instance the input interface 1110 may be used to receive instructions from an external computer device, receive instructions from a user (e.g., a touch sensitive display surface), etc. The computing device 1100 also includes an output interface 1112 that interfaces the computing device 1100 with one or more external devices. For example, the computing device 1100 may display text, images, etc. by way of the output interface 1112. Additionally while illustrated as a single system it is to be understood that the computing device 1100 may be a distributed system. Thus for instance, several devices may be in communication by way of a network connection and may collectively perform tasks described as being performed by the computing device 1100.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method comprising the following computer-executable acts:
receiving a first search query issued by a first user in a collaborative search environment;
executing a first search over contents of at least one data repository responsive to receipt of the first search query;
receiving a second search query issued by a second user in the collaborative search environment;
executing a second search over contents of the at least one data repository responsive to receipt of the second search query;
displaying on a display screen of a computing device a first graphical item that is representative of the first search, wherein the first graphical item includes first indicia that represents a first set of items retrieved during execution of the first search, and wherein the first graphical item includes second indicia that identifies a subset of items in the first set of items retrieved during execution of the first search that were also retrieved during execution of the second search.

2. The method of claim 1, further comprising displaying on the display screen of the computing device a second graphical item that is representative of the second search, wherein the second graphical item includes third indicia that represents a second set of items retrieved during execution of the second search, and wherein the second graphical item includes fourth indicia that identifies the subset of items in the second set of items retrieved during execution of the second search that were also retrieved during execution of the first search.

3. The method of claim 2, wherein the first graphical item includes fifth indicia that indicates that the first user issued the first search query, and wherein the second graphical item includes sixth indicia that indicates that the second user issued the second search query.

4. The method of claim 3, wherein the fifth indicia is a first color that is assigned to the first graphical item such that the first graphical item is rendered in the first color on the display screen of the computing device and the sixth indicia is a second color that is assigned to the second graphical item such that the second graphical item is rendered in the second color on the display screen of the computing device.

5. The method of claim 4, wherein the first and second graphical items are expandable, and further comprising:
receiving a command from one of the first user or the second user to expand the first graphical item; and
responsive to receipt of the command, displaying on the display screen the first indicia and the second indicia.

6. The method of claim 5, wherein the first indicia is a plurality of graphical rectangles, wherein each graphical rectangle in the plurality of graphical rectangles represents one item in the first set of items.

7. The method of claim 6, further comprising assigning the second indicia to a first graphical rectangle in the plurality of graphical rectangles to indicate that an item corresponding to the first graphical rectangle is included in the second set of items.

8. The method of claim 7, further comprising assigning a seventh indicia to the first graphical rectangle in the plurality of graphical rectangles to indicate that at least one of the first user or the second user has opened the item corresponding to the first graphical rectangle.

9. The method of claim 8, wherein the seventh indicia is a third color.

10. The method of claim 9, wherein shade of the third color alters as the item corresponding to the first graphical rectangle is opened by additional users.

11. The method of claim 1, wherein the collaborative search environment comprises a computer device that is simultaneously being utilized by the first user and the second user.

12. The method of claim 11, wherein the computer device is a touch-sensitive tabletop computing device.

13. The method of claim 1, wherein the collaborative search environment comprises a networked environment, wherein the first user is utilizing a first computing device that is in communication with a second computing device utilized by the second user.

14. The method of claim 1, wherein the first search and the second search are web-based searches conducted through use of a web browser and a web-based search engine.

15. The method of claim 1, wherein the first graphical item further includes third indicia that, for each item in the set items, indicates a number of times that the first search query appears in an item.

16. A system comprising the following computer-executable components:
a search component that executes a first search over contents of a data repository and outputs a first set of search results based at least in part upon a first search query and executes a second search over contents of the data repository and outputs a second set of search results based at least in part upon a second search query;
a search representor component that generates a first graphical item that is representative of the first search and causes the first graphical item to be displayed on a display screen of a computing device, wherein the first graphical item is expandable upon receipt of a command to expand the first graphical item, wherein the first graphical item when expanded comprises a first plurality of graphical items that are representative of the first set of search results retrieved during execution of the first search, and wherein at least one graphical item in the first plurality of graphical items comprises a first graphical indicia that indicates that a search result corresponding to the at least one graphical item is also included in second search results output upon execution of the second search.

17. The system of claim 16, wherein a touch-sensitive tabletop computing device comprises the search component and the search representor component.

18. The system of claim 16, wherein at least one of the first search or the second search is a web-based search.

19. The system of claim 16, wherein the first search query is issued by a first user and the second search query is issued by a second user.

20. A touch-sensitive tabletop computing device, wherein the touch-sensitive tabletop computing device comprises a processor and a computer-readable medium, wherein the computer-readable medium comprises instructions that, when executed by the processor, cause the processor to perform the following acts:
execute a first search over contents of a data repository in the touch-sensitive tabletop computing device, wherein the first search is executed responsive to receipt of a search query issued by a first user of the touch-sensitive tabletop computing device;
output a first set of search results upon executing the first search;
execute a second search over contents of the data repository in the touch-sensitive tabletop computing device, wherein the second search is executed responsive to receipt of a search query issued by a second user of the touch-sensitive tabletop computing device;
output a second set of search results upon executing the second search;
determine that at least one search result that is located in both the first set of search results and the second set of search results; and
generate a first graphical item that is representative of the first search, wherein the first graphical item comprises a plurality of graphical items that are representative of search results in the first set of search results, wherein at least one graphical item in the plurality of graphical items comprises a first graphical indicia that indicates that a search result corresponding to the at least one graphical item is included in both the first set of search results and the second set of search results.
